(19) United States
(12) Patent Application Publication
(10) Pub. No.: US 2007/0015052 A1
(43) Pub. Date: Jan. 18, 2007

(54) BATTERY TERMINAL

(75) Inventors: Luis Miguel Munoz, Valls (ES); Josep Maria Roset Rubio, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/904,375

(22) Filed: Jul. 14, 2005

(51) Int. Cl. H01M 2/30

(52) U.S. Cl. 429/178; 429/183

(57) ABSTRACT

Based on a body (1) wherein a clamp (2) is defined, with its corresponding screws (3) and nut (4), for the tightening thereof on the battery post, said body (1) incorporates at its end opposite to the clamp (2) a pair of cylindrical necks (6-9), with parallel axes, with opposite extensions (7) and (10), said necks having different diameters, such that they determine for the terminal two individual connection areas allowing for the coupling of a broad range of cables with different sections, both unitarily and in a group, in each one of said connection areas.

### OBJECT OF THE INVENTION

The present invention relates to a terminal, of those commonly used to connect the corresponding electric supply cable to a battery post, a terminal which has been designed and structured in order to allow for the possibility to connect cables with very different diameters thereto, and even more than one cable, with a perfect electric continuity.

Therefore, the object of the invention is to achieve a terminal allowing the use of different wiring sections in the same terminal of the battery and furthermore offering two individual and independent connection areas.

The invention is especially applicable in the automotive field, particularly in that of electrical installations for automobiles.

### BACKGROUND OF THE INVENTION

As is known, the current battery terminals are structured by means of a monopiece body, of a suitable electroconductive material, in which a cylindrical clamp is defined that is capable of being tightened on the battery post with the collaboration of a screw-nut assembly, a body provided in its middle area with a hole allowing for the passage of a screw for fixing any auxiliary element to the terminal, and at its other end incorporating a cylindrical neck, axially extended at one of its ends, such that this cylindrical neck is intended for receiving therein the end of the electric cable through which the battery is connected to the circuit to be fed.

The fixing of said cable to the aforementioned cylindrical neck is carried out by means of the introduction of the “stripped” end of the cable inside the neck and the subsequent radial contraction of the latter, in a clinching operation or the like, with a suitable tool.

This solution allows for the coupling of cables with different diameters to the terminal, but with a considerable limitation, which is determined by the diameter of the neck, corresponding to the maximum diameter of the cable, and by the maximum tightening which said neck can undergo without deterioration thereof.

Furthermore, it is occasionally necessary to connect more than one cable to the terminal, which obliges joining the different cables and introducing them together in the single neck of the terminal.

This implies the necessity to have a range of different terminals in practice, specifically with different diameters in their neck for connection of the cable, which negatively has an effect at both the manufacturing costs level and the stock level.

### DESCRIPTION OF THE INVENTION

The battery terminal proposed by the invention solves in a fully satisfactory manner the drawbacks set forth above, allowing for the use of very different wiring sections with a single terminal, as well as the independent fixing of two different cables when necessary.

To this end and more specifically, the terminal proposed by the invention, based on the basic structure previously described for a conventional terminal, i.e. the existence of a monopiece body with a clamp for coupling to the battery post, focuses its features on the fact that at its other end, the one opposite to said clamp, incorporates two cylindrical necks with different diameters such that, for a certain practical embodiment example of the terminal, the latter is able to receive cables with sections comprised between 16 and 35 mm, as well as combinations of cables of up to 57 mm, which is inconceivable with the known battery terminals.

According to another one of the features of the invention, it has been provided for said two cylindrical necks, with parallel axes, to have opposite extensions to facilitate the access to each one of them in the cable fixing operations.

### DESCRIPTION OF THE DRAWINGS

To complement the description being made and for the purpose of helping to better understand the features of the invention according to a preferred practical embodiment example thereof, a set of drawings is attached as an integral part of said description, wherein the following has been shown with an illustrative and non-limiting character:

FIG. 1 shows a perspective view of a battery terminal carried out according to the object of the present invention.

FIG. 2 shows a side elevational view of the same terminal, wherein the difference in diameter existing between the two necks thereof is more clearly observed.

FIG. 3 finally shows a plan view of the terminal to which the cables are shown connected.

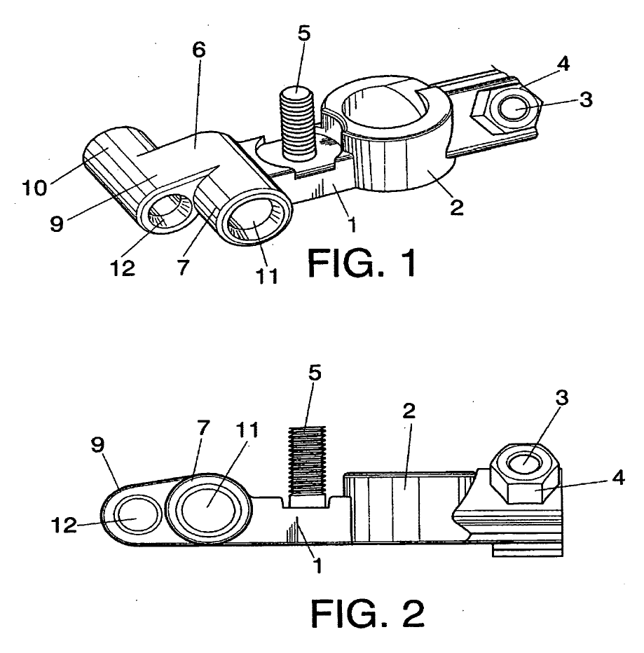

### PREFERRED EMBODIMENT OF THE INVENTION

In view of the mentioned figures, it can be observed how the battery terminal proposed by the present invention has, like any standard terminal, a body (1) finished off at one of its ends in a cylindrical clamp (2) with its corresponding screw (3)—nut (4) assembly for the tightening thereof on the battery post, a body (1) which may incorporate in its middle area a screw (5) for the fixing of auxiliary elements, and which at its other end incorporates a cylindrical neck (6), with a transverse axis with regard to the longitudinal direction of the body (1), with an extension (7) at one of its ends provided for being radially deformed against the corresponding cable (8) for the mechanical fixing and connection thereof in a clinching operation with the suitable tool.

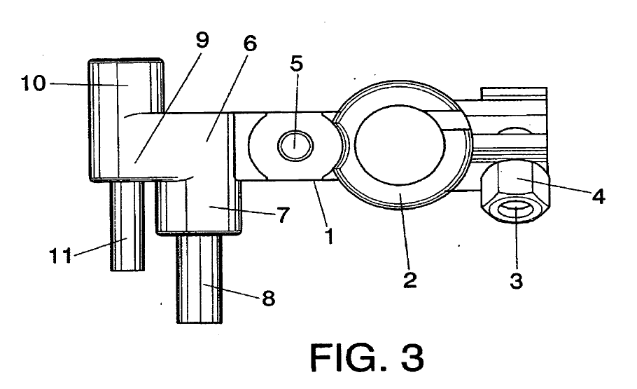

Thus, according to the invention, the terminal incorporates a second cylindrical neck (9) with a different diameter than the first one (6), with an axis parallel to the latter's, and with an axial extension (10) at one of its ends, specifically an extension (10) opposite to the extension (7) of the first neck (6), this second neck (9) being intended for receiving in turn a second cable (11), in this case with a smaller diameter, as inferred from observing FIG. 3.

The neck (7) is able to receive a cable or group of cables, the effective diameter of which coincides with that of its own hole (11), as well as cables or groups of cables with smaller diameters, over which it will be deformed in any case by means of radial contraction, while at the same time the hole (12) corresponding to the neck (9), due to its different diameter, is in turn able to receive another cable or group of cables with a smaller section.

From the practical point of view, the assembly of the cables (8) and (11) will be carried out sequentially, such that after the fixing of one of them (8), the second one (11) will then be fixed, both cables (8) and (11) being oriented in the same direction so that the one which was assembled first does not interfere in the fixing maneuver of the second one.

What is claimed is:

1- A battery terminal, of the type of those constituted by means of a monopiece body based on an electroconductive material, wherein a cylindrical clamp is defined for the coupling to the post of the battery and the fixing thereto with the collaboration of a nut-locknut assembly, a body in its middle area being susceptible of incorporating a screw for the fixing of auxiliary elements, and at its other end being finished off in a cylindrical neck extended at one of its ends, intended for receiving the end of the corresponding electric supply cable or group of cables and for tightening its extension over said cables by means of radial contraction thereof, characterized in that together with said cylindrical neck (6), it also has a second cylindrical neck (9), having a axis parallel to the first one and with a different inner diameter, likewise provided with an axial extension (10) which can be tightened over the corresponding cable or group of cables (11), such that a single terminal incorporates two individual and independent cable receiving areas, allowing for the connection of a broad range of cables with different sections.

2- A battery terminal according to claim 1, characterized in that the extensions (7-10) of the two cylindrical necks (6-9) adopt opposite arrangements to facilitate the access to each one of them for the tool for tightening such extensions over the respective cables or groups of cables.
